(19) United States
(12) Patent Application Publication
(10) Pub. No.: US 2026/0343405 A1
(43) Pub. Date: Oct. 29, 2026

(54) COMMON INFORMATION TRANSMISSIONS IN WIRELESS COMMUNICATIONS

(71) Applicant: ZTE Corporation, Shenzhen (CN)

(72) Inventors: Jing SHI, Shenzhen (CN); Xianghui HAN, Shenzhen (CN); Bo DAI, Shenzhen (CN); Mengzhu CHEN, Shenzhen (CN); Xuan MA, Shenzhen (CN)

(73) Assignee: ZTE Corporation, Shenzhen (CN)

(21) Appl. No.: 19/705,267

(22) Filed: Jun. 11, 2026

Related U.S. Application Data
(63) Continuation of application No. PCT/CN2024/074789, filed on Jan. 30, 2024.

(51) Int. Cl. H04W 52/02

(52) U.S. Cl. CPC H04W 52/0206; H04W 52/0235

(57) ABSTRACT

This document generally relates to wireless communication involving a user device that transmits, and a network device that receives, a wake-up signal (WUS). The network device transmits, and the user device receives, a second common information that includes a WUS configuration corresponding to the WUS. After the network device transmits the second common information and/or the user device receives the second common information, the network device transmits the user device receives first common information, wherein communication of the first common information is triggered by the WUS.

### CROSS-REFERENCE TO RELATED APPLICATION(S)

This application is a continuation of International Patent Application No. PCT/CN2024/074789, filed Jan. 30, 2024. The contents of International Patent Application No. PCT/CN2024/074789 are herein incorporated by reference in their entirety.

### TECHNICAL FIELD

This document is directed generally to common information transmissions in wireless communications.

### BACKGROUND

Wireless communication system involving mobile communication technology (e.g., 5th Generation mobile communication technology (5G) or further 6th Generation mobile communication technology (6G)) continually face more and more demands, including systems implementing enhanced mobile broadband (eMBB), ultra-reliable low-latency communication (URLLC), and/or massive machine-type communication (mMTC). To meet the demands, network energy saving (NES) may be implemented in order to improve the efficiency of communication system.

Moreover, in wireless communication systems, network energy saving is of great importance for environmental sustainability, reducing environmental impact (e.g., greenhouse gas emissions), and for operational cost savings. In that regard, energy consumption has become a key part of operators' operating expenditure (OPEX). Time-domain positions of transmitted common information, signal or channel (e.g., a synchronization signal block (SSB), a system information signal block 1 (SIB1), or others), within a period are semi-statically determined. The transmission of common information, or reception of information from another device, such as random-access signals, may limit the network to use sleep modes to save energy. Ways to save energy for transmissions of common information may be desirable.

### SUMMARY

This document relates to methods, systems, apparatuses and devices for wireless communication. In some implementations, a method for wireless communication includes: transmitting, by a user device, a wake-up signal (WUS) to a network device; receiving, by the user device, second common information that includes a WUS configuration corresponding to the WUS; and after receiving the second common information, receiving, by the user device, first common information, wherein transmission of the first common information is triggered by the WUS.

In some other implementations, a method for wireless communication includes: receiving, by a network device, a wake-up signal (WUS) from a user device; transmitting, by the network device, second common information that includes a WUS configuration corresponding to the WUS; and after transmitting the second common information, transmitting, by the network device, first common information, wherein transmission of the first common information is triggered by the WUS.

In some other implementations, a device, such as a network device, is disclosed. The device may include one or more processors and one or more memories, wherein the one or more processors are configured to read computer code from the one or more memories to implement any of the methods above.

In yet some other implementations, a computer program product is disclosed. The computer program product may include a non-transitory computer-readable program medium with computer code stored thereupon, the computer code, when executed by one or more processors, causing the one or more processors to implement any of the methods above.

The above and other aspects and their implementations are described in greater detail in the drawings, the descriptions, and the claims.

### BRIEF DESCRIPTION OF THE DRAWINGS

FIG. 1 shows a block diagram of an example of a wireless communication system.

FIG. 2 shows a flow chart of a method for wireless communication.

FIG. 3 shows a flow chart of another method for wireless communication.

FIG. 4 shows a schematic diagram of a wireless communication configuration in a single cell, where an on-demand system information block 1 (SIB1) is triggered by a wake-up signal (WUS), and a WUS configuration for the WUS is carried a synchronization signal (SS)/physical broadcast channel (PBCH) block (SSB).

FIG. 5 shows a schematic diagram of synchronization signal/physical broadcast channel blocks (SSBs) transmitted on certain global synchronization channel numbers (GSCNs).

FIG. 6 shows a schematic diagram of an example of a WUS indicating scheduling information for a SIB1.

FIG. 7 shows a schematic diagram of an example transmission on anchor and non-anchor cells/carriers.

FIG. 8 shows a schematic diagram of another example transmission on anchor and non-anchor cells/carriers.

FIG. 9 shows a schematic diagram of the first condition, where a physical downlink control channel (PDCCH) used for scheduling a SIB1 is not detected within Y time durations or periods.

FIG. 10 shows a schematic diagram of periodic transmission of a SIB1 after WUS reception.

FIG. 11 shows a schematic diagram of an example of a WUS sent one or more times in a WUS window with multiple WUS occasions.

FIG. 12 shows a schematic diagram of a SIB1 sent periodically within a SIB1 window.

### DETAILED DESCRIPTION

The present description describes various embodiments of systems, apparatuses, devices, and methods for wireless communications related common information transmissions.

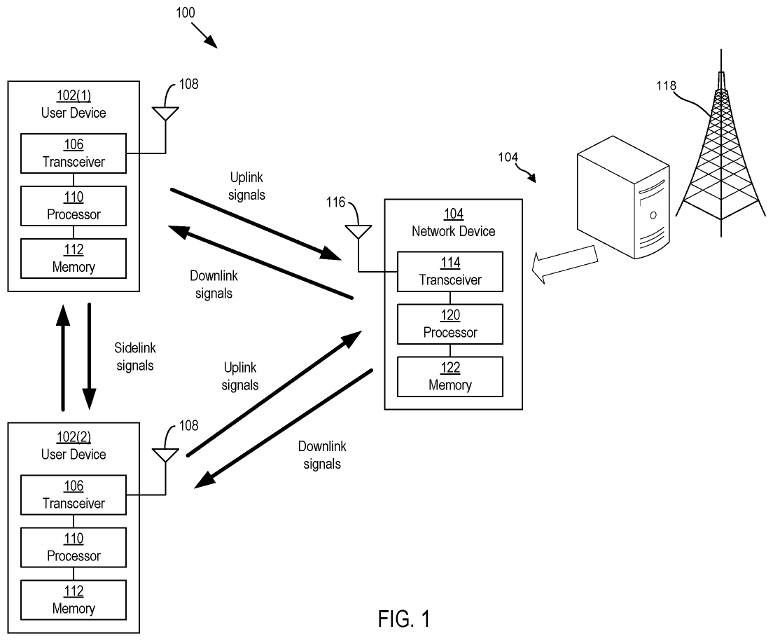

FIG. 1 shows a diagram of an example wireless communication system 100 including a plurality of communication nodes (or just nodes) that are configured to wirelessly communicate with each other. In general, the communication nodes include at least one user device 102 and at least one network device 104. The example wireless communication system 100 in FIG. 1 is shown as including two user devices 102, including a first user device 102(1) and a second user device 102(2), and one device 104. However, various other examples of the wireless communication system 100 that include any of various combinations of one or more user devices 102 and/or one or more network devices 104 may be possible.

In general, a user device as described herein, such as the user device 102, may include a single electronic device or apparatus, or multiple (e.g., a network of) electronic devices or apparatuses, capable of communicating wirelessly over a network. A user device may comprise or otherwise be referred to as a user terminal, a user terminal device, or a user equipment (UE). Additionally, a user device may be or include, but not limited to, a mobile device (such as a mobile phone, a smart phone, a smart watch, a tablet, a laptop computer, vehicle or other vessel (human, motor, or engine-powered, such as an automobile, a plane, a train, a ship, or a bicycle as non-limiting examples) or a fixed or stationary device, (such as a desktop computer or other computing device that is not ordinarily moved for long periods of time, such as appliances, other relatively heavy devices including Internet of things (IoT), or computing devices used in commercial or industrial environments, as non-limiting examples). In various embodiments, a user device 102 may include transceiver circuitry 106 coupled to an antenna 108 to effect wireless communication with the network device 104. The transceiver circuitry 106 may also be coupled to a processor 110, which may also be coupled to a memory 112 or other storage device. The memory 112 may store therein instructions or code that, when read and executed by the processor 110, cause the processor 110 to implement various ones of the methods described herein.

Additionally, in general, a network device as described herein, such as the network device 104, may include a single electronic device or apparatus, or multiple (e.g., a network of) electronic devices or apparatuses, and may comprise one or more wireless access nodes, base stations, or other wireless network access points capable of communicating wirelessly over a network with one or more user devices and/or with one or more other network devices 104. For example, the network device 104 may comprise a 4G LTE base station, a 5G NR base station, a 5G central-unit base station, a 5G distributed-unit base station, a next generation Node B (gNB), an enhanced Node B (eNB), or other similar or next-generation (e.g., 6G) base stations, in various embodiments. A network device 104 may include transceiver circuitry 114 coupled to an antenna 116, which may include an antenna tower 118 in various approaches, to effect wireless communication with the user device 102 or another network device 104. The transceiver circuitry 114 may also be coupled to one or more processors 120, which may also be coupled to a memory 122 or other storage device. The memory 122 may store therein instructions or code that, when read and executed by the processor 120, cause the processor 120 to implement one or more of the methods described herein.

In various embodiments, two communication nodes in the wireless system 100—such as a user device 102 and a network device 104, two user devices 102 without a network device 104, or two network devices 104 without a user device 102—may be configured to wirelessly communicate with each other in or over a mobile network and/or a wireless access network according to one or more standards and/or specifications. In general, the standards and/or specifications may define the rules or procedures under which the communication nodes can wirelessly communicate, which, in various embodiments, may include those for communicating in millimeter (mm)-Wave bands, and/or with multi-antenna schemes and beamforming functions. In addition or alternatively, the standards and/or specifications are those that define a radio access technology and/or a cellular technology, such as Fourth Generation (4G) Long Term Evolution (LTE), Fifth Generation (5G) New Radio (NR), or New Radio Unlicensed (NR-U), as non-limiting examples.

Additionally, in the wireless system 100, the communication nodes are configured to wirelessly communicate signals between each other. In general, a communication in the wireless system 100 between two communication nodes can be or include a transmission or a reception, and is generally both simultaneously, depending on the perspective of a particular node in the communication. For example, for a given communication between a first node and a second node where the first node is transmitting a signal to the second node and the second node is receiving the signal from the first node, the first node may be referred to as a source or transmitting node or device, the second node may be referred to as a destination or receiving node or device, and the communication may be considered a transmission for the first node and a reception for the second node. Of course, since communication nodes in a wireless system 100 can both send and receive signals, a single communication node may be both a transmitting/source node and a receiving/destination node simultaneously or switch between being a source/transmitting node and a destination/receiving node.

Also, particular signals can be characterized or defined as either an uplink (UL) signal, a downlink (DL) signal, or a sidelink (SL) signal. An uplink signal is a signal transmitted from a user device 102 to a network device 104. A downlink signal is a signal transmitted from a network device 104 to a user device 102. A sidelink signal is a signal transmitted from a one user device 102 to another user device 102, or a signal transmitted from one network device 104 to a another network device 104. Also, for sidelink transmissions, a first/source user device 102 directly transmits a sidelink signal to a second/destination user device 102 without any forwarding of the sidelink signal to a network device 104.

Additionally, signals communicated between communication nodes in the system 100 may be characterized or defined as a data signal or a control signal. In general, a data signal is a signal that includes or carries data, such multimedia data (e.g., voice and/or image data), and a control signal is a signal that carries control information that configures the communication nodes in certain ways in order to communicate with each other, or otherwise controls how the communication nodes communicate data signals with each other. Also, certain signals may be defined or characterized by combinations of data/control and uplink/downlink/sidelink, including uplink control signals, uplink data signals, downlink control signals, downlink data signals, sidelink control signals, and sidelink data signals.

For at least some specifications, such as 5G NR, data and control signals are transmitted and/or carried on physical channels. Generally, a physical channel corresponds to a set of time-frequency resources used for transmission of a signal. Different types of physical channels may be used to transmit different types of signals. For example, physical data channels (or just data channels), also herein called traffic channels, are used to transmit data signals, and physical control channels (or just control channels) are used to transmit control signals. Example types of traffic channels (or physical data channels) include, but are not limited to, a physical downlink shared channel (PDSCH) used to communicate downlink data signals, a physical uplink shared channel (PUSCH) used to communicate uplink data signals, and a physical sidelink shared channel (PSSCH) used to communicate sidelink data signals. In addition, example types of physical control channels include, but are not limited to, a physical downlink control channel (PDCCH) used to communicate downlink control signals, a physical uplink control channel (PUCCH) used to communicate uplink control signals, and a physical sidelink control channel (PSCCH) used to communicate sidelink control signals. As used herein for simplicity, unless specified otherwise, a particular type of physical channel is also used to refer to a signal that is transmitted on that particular type of physical channel, and/or a transmission on that particular type of transmission. As an example illustration, a PDSCH refers to the physical downlink shared channel itself, a downlink data signal transmitted on the PDSCH, or a downlink data transmission. Accordingly, a communication node transmitting or receiving a PDSCH means that the communication node is transmitting or receiving a signal on a PDSCH.

Additionally, for at least some specifications, such as 5G NR, and/or for at least some types of control signals, a control signal that a communication node transmits may include control information comprising the information necessary to enable transmission of one or more data signals between communication nodes, and/or to schedule one or more data channels (or one or more transmissions on data channels). For example, such control information may include the information necessary for proper reception, decoding, and demodulation of a data signals received on physical data channels during a data transmission, and/or for uplink scheduling grants that inform the user device about the resources and transport format to use for uplink data transmissions. In some embodiments, the control information includes downlink control information (DCI) that is transmitted in the downlink direction from a network device 104 to a user device 102. In other embodiments, the control information includes uplink control information (UCI) that is transmitted in the uplink direction from a user device 102 to a network device 104, or sidelink control information (SCI) that is transmitted in the sidelink direction from one user device 102(1) to another user device 102(2).

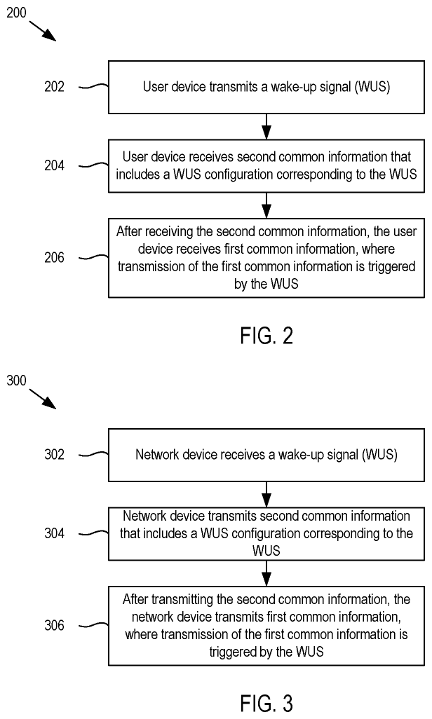

FIG. 2 is a flow chart of an example method 200 of wireless communication involving common information. At block 202, a user device 102 transmits a wake-up signal (WUS). At block 204, the user device 102 receives second common information that includes a WUS configuration corresponding to the WUS. At block 206, after receiving the second common information, the user device 102 receives first common information, wherein transmission and/or receipt of the first common information is triggered by the WUS. Additionally, in some embodiments, the first common information is considered or includes on-demand first common information, in that the first common information is received by the user device 102 in an on-demand manner through communication of the WUS to trigger the communication of the first common information.

FIG. 3 is a flow chart of another example method 300 of wireless communication involving common information. At block 302, a network device 104 receives a wake-up signal (WUS). At block 304, the network device 104 transmits second common information that includes a WUS configuration corresponding to the WUS. At block 306, after transmitting the second common information, the network device 104 transmits first common information, wherein transmission of the first common information is triggered by the WUS. Additionally, in some embodiments, the first common information is considered or includes on-demand first common information, in that the first common information is transmitted to the user device 102 in an on-demand manner through communication of the WUS to trigger the communication of the first common information.

In some embodiments of the method 200 and/or the method 300, the WUS configuration is delivered by the second common information by: being indicated by one bit or one state in a master information block (MIB) of the second common information, wherein the one bit or the one state is used to indicate one of two predefined WUS configurations, or to indicate whether only one default predefined WUS configuration is delivered by the MIB; being indicated by one bit or one state in a MIB of the second common information to indicate that at least one other field of the MIB represents an indication of the WUS configuration; being associated with at least one synchronization signal (SS)/physical broadcast channel (PBCH) block (SSB) or a number of actually received SSBs in a period; being associated with at least one global synchronization channel number (GSCN); being associated with at least one cell identifier (ID); or being associated with at least one state or field of a MIB of the second common information. For some of these embodiments, the WUS configuration is applied to a carrier or cell which is the same as or different than a cell or carrier used for the second common information transmission.

In addition or alternatively, in some embodiments of the method 200 and/or the method 300, the transmission of the first common information is triggered by the WUS in a physical downlink control channel (PDCCH)-less manner. In some of these embodiments, a frequency domain resource including at least one of a start location or a size of a system information block 1 (SIB1) of the first common information is indicated by a master information block (MIB). In addition or alternatively, scheduling information for the SIB1 is explicitly or implicitly indicated by the WUS. In some of these embodiments, the scheduling information includes a start symbol or a start slot for the SIB1, which is from an end symbol or an end slot of the WUS.

In addition or alternatively, in some embodiments of the method 200 and/or the method 300, the WUS is transmitted on a cell or a carrier, and the transmission of the first common information is triggered by the WUS on: the cell or the carrier; another cell or another carrier; or a plurality of other cells or a plurality of other carriers. In some of these embodiments, the cell comprises an anchor cell and/or the carrier comprises an anchor carrier. In addition or alternatively, in some of these embodiments, the another cell comprises a non-anchor cell, the another carrier comprises a non-anchor carrier, the plurality of other cells comprises a plurality of non-anchor cells, and/or the plurality of other carriers comprises a plurality of non-anchor carriers. In addition or alternatively, in some of these embodiments, the WUS includes a cell indication or a carrier indication for the first common information transmission.

In addition or alternatively, in some embodiments of the method 200 and/or the method 300, at least one of the WUS transmission or a request for the WUS configuration is made in response to occurrence of a condition, wherein the condition includes one of: a physical downlink control channel (PDCCH) used for scheduling a system information block 1 (SIB1) of the first common information is not detected within a predetermined X occasions and/or a predetermined Y periods or time durations, wherein each of X and Y is an integer; a timer used for SIB1 reception, starting a WUS transmission, or starting a WUS configuration request has expired; or at least one synchronization signal and physical broadcast channel (PBCH) block (SSB) of the second common information is received within a predetermined Z times or a predetermined P time durations or periods, wherein each of Z and P is an integer.

In addition or alternatively, in some embodiments of the method 200 and/or the method 300, a correspondence between the WUS and the first common information includes: the first common information is transmitted periodically after being triggered by the WUS until occurrence of a cell off event. In some of these embodiments, the WUS is transmitted one or more times until the first common information is received.

In addition or alternatively, in some embodiments of the method 200 and/or the method 300, a correspondence between the WUS and the first common information includes: the WUS is transmitted one or more times in a WUS window or a duration with one or more WUS occasions. In some of these embodiments, one or more subsequent WUSs are not sent in the WUS window or the duration in response to the on-demand first common information being received.

In addition or alternatively, in some embodiments of the method 200 and/or the method 300, a correspondence between the WUS and the first common information includes: the first common information is sent one or more times after being triggered by the WUS. In some of these embodiments, the first common information is transmitted periodically within a predetermined Y periods after being triggered by the WUS, wherein Y is an integer. In addition or alternatively, in some of these embodiments, the first common information is transmitted within a predetermined time window after the transmission of the first common information is triggered by the WUS.

Further details of actions performed by one or more communication nodes in the wireless communication system 100, any of which may be incorporated into any of various implementations of the method 200, the method 300, and/or other methods, are now described.

For at least some implementations, a synchronization signal and physical broadcast channel (PBCH) block (SSB) may include a primary synchronization signal (PSS) and a secondary synchronization signal (SSS), each occupying one symbol and 127 subcarriers, and a PBCH spanning across three orthogonal frequency division multiplexing (OFDM) symbols and 240 subcarriers, where one symbol is designated as an unused part in the middle for SSS. Possible time locations of SSBs within a half-frame may be determined by sub-carrier spacing and the periodicity of the half-frames where SSBs are transmitted may be configured by the network device 104. During a half-frame, different SSBs may be transmitted in different spatial directions (e.g., by using different beams or by spanning the coverage area of a cell). Within the frequency span of a carrier, multiple SSBs can be transmitted. Additionally, the physical cell identities (PCIs) of SSBs transmitted in different frequency locations do not have to be unique. That is, different SSBs in the frequency domain can have different PCIs. However, when an SSB is associated with a remaining minimum system information (RMSI), the SSB corresponds to an individual cell, which has a unique NR cell global identifier (NCGI). Such an SSB is referred to as a cell-defining SSB (CD-SSB). A primary cell (Pcell) is may be (and in some implementations always) associated with a CD-SSB located on the synchronization raster.

Additionally, a master information block (MIB) on a PBCH provides a user device 102 with parameters (e.g. a control resource set (CORESET) #0 configuration) for monitoring of PDCCH and/or for scheduling a PDSCH that carries the system information block 1 (SIB1). A PBCH may also indicate that there is no associated SIB1, in which case the user device 102 may be pointed to another frequency from where to search for an SSB that is associated with a SIB1 as well as a frequency range where the user device 102 may assume no SSB associated with SIB1 is present. The indicated frequency range is confined within a contiguous spectrum allocation of the same operator in which SSB is detected.

Accordingly, after the user device 102 receives a SSB, in case no SIB1 is indicated by the PBCH, the user device 102 will search another frequency; otherwise, the user device 102 may monitor a PDCCH for scheduling the SIB1. Various ways of implementing on-demand SIB1 transmissions are described in the following sections. Also, of note, SIB1 is just one example of common information. Correspondingly, while various on-demand transmissions are described below in the context of SB1, similar on-demand transmissions may be performed for other types of common information. That is, the embodiments described below for on-demand SIB1 transmissions may also be applied to on-demand common information transmissions in general.

Also, of note, in any of various embodiments, the first common information may be or include a SIB1, a SIB other than a SIB1, a paging information, a random access response (RAR), a PDSCH, and/or a PDCCH. In addition or alternatively, in any of various embodiments, the second common information may be or include a MIB, a SSB, a PSS, a SSS, a SIB1, a SIB other than a SIB1, and/or a PDCCH.

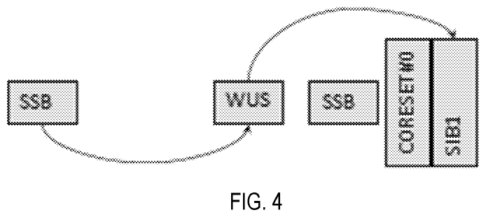

In some embodiments, an on-demand transmission of first common information transmission (e.g. SIB1) may be triggered by a wake-up signal (WUS), which is transmitted from another device (or communication node in the wireless communication system 100). In any of various implementations, a WUS is a signal or channel (e.g. a physical random access channel (PRACH), a discovery reference signal (DRS), a pulse signal, a PUSCH, a PUCCH, a sounding reference signal (SRS), or a reference signal, as non-limiting examples. Additionally, a WUS configuration may be carried by a second common information, which may be or include second common information carried by a Layer 1 (L1) signal/channel (e.g., SSB, DRS, or PDCCH) or core network, and which may be transmitted before the first common information. In some embodiments, a request for the WUS configuration may be sent from the another device. For example, FIG. 4 shows a schematic diagram of a wireless communication configuration in a single cell, where an on-demand SIB1 is triggered by a WUS, and a WUS configuration for the WUS is carried the SSB.

Additionally, in some embodiments, a WUS configuration may be explicitly indicated by an SSB according to or using one or more of the following schemes.

In a first scheme, a WUS configuration is indicated by one bit or one state in a master information block (MIB). For example, the one bit may be a spare bit. Using one bit, only one of two predefined WUS configurations can be indicated. That is, the bit values ‘0’ and ‘1’ for the one bit may each be respectively associated with and/or used to respectively indicate one of two predefined WUS configurations. In some implementations, only one default predefined WUS configuration can be indicated, where one of the bit values ‘0’ and ‘1’ of the one bit indicates or is associated with the default predefined WUS configuration, and the other of the bit values ‘0’ and ‘1’ of the one bit indicates or is used to represent a reserved state or no WUS configuration. For example, one state may be kSSB=30 for a first frequency range (FR1), and kSSB=14 for a second frequency range (FR2), where kSSB is an offset of the SSB sub-carrier. For example, kSSB=30 for FR1 and kSSB=14 for FR2 is a reserved state, which may be used for kSSB to indicate a default predefined WUS configuration.

In a second scheme, one bit or one state in a MIB is used to indicate at least one other field in the MIB used to represent the indication of the WUS configuration. For example, the one bit may be a spare bit or a cellBarred bit. As another example, one state may be kSSB=30 for FR1 and kSSB=14 for FR2. In addition or alternatively, the at least one other field in the MIB may be ssb-SubcarrierOffset (the frequency domain offset between SSB and the overall resource block grid in number of subcarriers) or pdcch-ConfigSIB (a parameter providing a control resource set (CORESET) and a common search space type #0 in the MIB).

For example, in some embodiments, a spare bit is set to bit value of ‘0’ or ‘1’ to represent the legacy indication of N_{GSCN}^{Offset}, as shown below in Table 1 or Table 2, or to represent the indication of WUS configurations by kSSB.

TABLE 1
Mapping between the combination of k_{SSB} and
controlResourceSetZero and searchSpaceZero in pdcch-ConfigSIB1
to N_{GSCN}^{Offset} for FR1

| | 16 × controlResourceSetZero + | |
|---|---|---|
| k_{SSB} | searchSpaceZero | N_{GSCN}^{Offset} |
| 24 | 0, 1, . . . , 255 | 1, 2, . . . , 256 |
| 25 | 0, 1, . . . , 255 | 257, 258, . . . , 512 |
| 26 | 0, 1, . . . , 255 | 513, 514, . . . , 768 |
| 27 | 0, 1, . . . , 255 | −1, −2, . . . , −256 |
| 28 | 0, 1, . . . , 255 | −257, −258, . . . , −512 |
| 29 | 0, 1, . . . , 255 | −513, −514, . . . , −768 |
| 30 | 0, 1, . . . , 255 | Reserved, Reserved, . . . , |
| | | Reserved |

TABLE 2
Mapping between the combination of k_{SSB} and
controlResourceSetZero and searchSpaceZero in pdcch-ConfigSIB1
to N_{GSCN}^{Offset} for FR2

| | 16 × controlResourceSetZero + | |
|---|---|---|
| k_{SSB} | searchSpaceZero | N_{GSCN}^{Offset} |
| 12 | 0, 1, . . . , 255 | 1, 2, . . . , 256 |
| 13 | 0, 1, . . . , 255 | −1, −2, . . . , −256 |
| 14 | 0, 1, . . . , 255 | Reserved, Reserved, . . . , |
| | | Reserved |

In some embodiments, the spare bit may be combined with pdcch-ConfigSIB1, such as by using some or all values of k_{SSB}>23 for FR1 and/or k_{SSB}>11 for FR2 to indicate one of one or more WUS configurations. In addition or alternatively, an 8-bit value for pdcch-ConfigSIB1 may be used to indicate a WUS configuration. After a WUS received by a network device 104 (e.g., gNB), k_{SSB}≤23 for FR1 and k_{SSB}≤11 for FR2 may be indicated. In addition or alternatively, at least one value is reserved to indicate SSB without remaining minimum system information (RMSI), where up to seven WUS configurations for FR1 and up to three WUS configurations for FR2 can be supported. In addition or alternatively, an on-demand SIB1 can be regarded as a specific SSB without RMSI. For example, for FR1, k_{SSB}=24 to 31 to represent different requirements of SIB1, and different WUS configurations may be associated with different requirements of SIB1. In a particular example, k_{SSB}=24 to represent no need of SIB1, and k_{SSB}=25 to 31 to represent different requirements (e.g., period or density) of SIB1.

For example, one state of kSSB=30 for FR1 and kSSB=14 for FR2 may be used to represent the indication of the WUS configuration by pdcch-ConfigSIB1 or to indicate the WUS configuration or one of multiple predefined WUS configurations. In addition or alternatively, the PDCCH configuration used for monitoring PDCCH may be used for scheduling/indicating the WUS configuration.

In addition or alternatively, in some embodiments, a cellBarred bit may be set to “barred”, which may represent that a WUS configuration is indicated by at least one other field (e.g., kSSB or pdcch-ConfigSIB1) in the MIB to indicate the WUS configuration. In some of these embodiments, another bit (e.g., a spare bit) may be used to indicate that the cellBarred bit set to “barred” represents that a WUS configuration is indicated by at least one other field in the MIB.

Accordingly, using the above-described schemes for explicit indication, implementation of on-demand common information transmission can be achieved by WUS triggering through use of the corresponding WUS configuration, which may be provided by other common information transmitted before the on-demand common information transmission. As described in these schemes, the WUS configuration may be indicated explicitly by specific existing field(s) of the other common information. In addition or alternatively, another element or field, such as kSSB or pdcch-ConfigSIB1, may be reinterpreted or represented as an indication of a WUS configuration, and that other element or field may itself be indicated by another element, such as a spare bit or a cellBarred bit, as previously described. As a result, on-demand common information transmission may be performed with relatively low complexity.

In addition alternatively, a WUS configuration may be implicitly indicated by a SSB according to one or more of the following schemes.

In a first scheme, a WUS configuration may be associated with at least one SSB index or a number of received SSBs. For example, within a type of SSB pattern, a maximum number of SSBs within a period (e.g. a half frame as a non-limiting example) is L (e.g., L=4, 8, or 64 as non-limiting examples). For a case with a maximum L, the WUS configuration may be associated with one or more SSBs. As another example, the WUS configuration may be associated with a number of received SSBs within N periods. Also, for at least some embodiments, different Ls may be associated with different WUS configurations. For at least some of these embodiments, the network device 104 (e.g., gNB) may blind detect a WUS based on different WUS configurations, which is depended on the actually received SSBs of a user device 102. For example, in case L=4, the network device 104 (e.g., gNB) may send an actual number of SSBs of L1≤4. In turn, the user device 102 may detect an actual number of SSBs to be L2≤L1. Also, the user device 102 may send a WUS based on a WUS configuration associated with the number of received SSBs L2. To illustrate, suppose L=4 with SSB index=0,1,2,3, where the same WUS configuration or different WUS configuration is associated with each SSB index. Further, suppose the network device 104 (e.g., gNB) may send an actual number of SSBs to be L1≤4. In turn, a user device 102 may detect an actual number of SSBs to be L2≤L1. Also, the user device 12 may send a WUS based on a WUS configuration associated with number of actually received SSBs.

In a second scheme, a WUS configuration is associated with at least one global synchronization channel number (GSCN). Example parameters of GSCN are shown in Table 3 below.

TABLE 3
GSCN parameters for the global frequency raster

| Frequency | SS Block frequency position | | Range of |
|---|---|---|---|
| range | SS_{REF} | GSCN | GSCN |
| 0-3000 | N * 1200 kHz + M * 50 kHz, | 3N + (M − | 2-7498 |
| MHz | N = 1:2499, M ϵ {1, 3, 5} (Note | 3)/2 | |
| | 1) | | |
| 3000- | 3000 MHz + N * 1.44 MHz | 7499 + N | 7499-22255 |
| 24250 | N = 0:14756 | | |
| MHz | | | |

(NOTE 1):
The default value for operating bands with which only support SCS spaced channel raster(s) is M = 3.

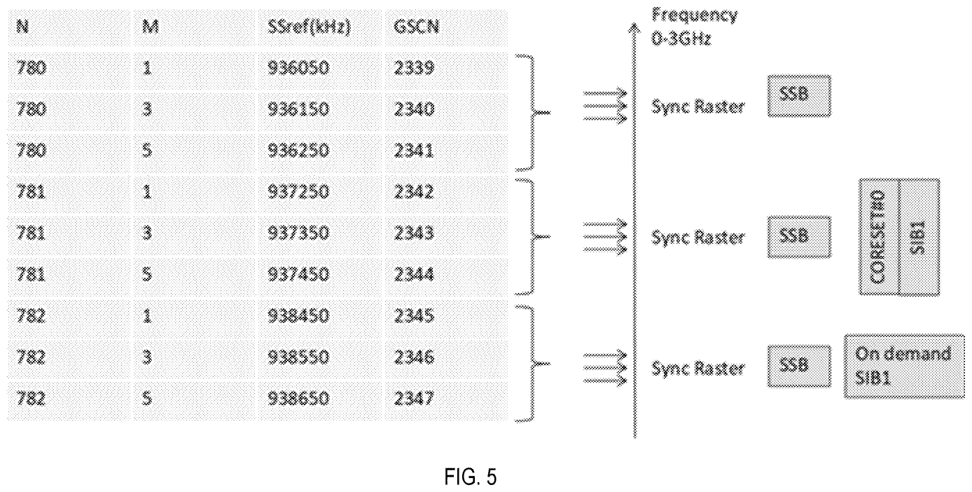

In some embodiments, on-demand SIB1 may be only supported by the at least one GSCN, where the same WUS configuration or different WUS configurations may be associated with each of the at least one GSCN. In some of these embodiments, a specific GSCN can be supported within each, some, or all values of N with a specific M. In a non-limiting example, the specific M is one of M={1,3,5}, which can be applied for the band supporting a 100 kiloHertz (khz) channel raster. In addition or alternatively, in some of these embodiments, a specific GSCN can be supported within at least one of the values of N with M=3. For example, at least one of the values of N belong to one band, which can be applied for the band supporting subcarrier spacing (SCS) spaced channel raster. To illustrate, FIG. 5 shows a schematic diagram of SSBs transmitted on certain GSCNs. For example, as shown in FIG. 5, SSBs without SIB 1 are transmitted on a certain one or more GSCNs, e.g., GSCN=2340; SSBs with SIB1 are transmitted on a certain one or more GSCNs, e.g. GSCN=2343; and SSBs with on-demand SIB1 are transmitted on a certain one or more GSCNs, e.g. GSCN=2346. Using the example illustrated in FIG. 5, the user device 102 may send a WUS based on a WUS configuration associated with a received SSB on GSCN=2346. In turn, the network device 104 may send SIB1 after, or in response to, receiving the WUS.

In a third scheme, a WUS configuration is associated with at least one cell identifier (ID). In some embodiments, the at least one cell ID may include at least one physical cell ID (PCID). In addition or alternatively, for at least some embodiments of this third scheme, a potential maximum number of cell IDs is N (e.g., N=504 or 1008 as non-limiting examples). The WUS configuration may be associated with one or more specific physical cell identifiers (PCID) determined after the user device 102 detects a primary synchronization signal (PSS) and/or a secondary synchronization signal (SSS). After detecting the specific PCID, the user device 102 may determine or be aware of the WUS configuration, and in turn, the user device 102 may send the WUS to trigger the on-demand SIB1. In response to, or after, receiving the WUS, the network device 104 may send the SIB1. In some of these embodiments, the PSS and/or the SSS may be not combined with the PBCH. For at least some of these embodiments, the network device 104 may send the PBCH, the SSB, and/or the SIB1 after receiving the WUS.

In a fourth scheme, a WUS configuration is associated with at least one state or field of MIB. At least some embodiments of the fourth scheme may include or involve MIB information, an example of which is provided below are listed below.

TABLE 4
Pseudocode of example MIB information

MIB ::= SEQUENCE {
systemFrameNumber BIT STRING (SIZE (6)),
subCarrierSpacingCommon ENUMERATED {scs15or60,
scs30or120},
ssb-SubcarrierOffset INTEGER (0..15),
dmrs-TypeA-Position ENUMERATED {pos2, pos3},
pdcch-ConfigSIB1 PDCCH-ConfigSIB1,
cellBarred ENUMERATED {barred, notBarred},
intraFreqReselection ENUMERATED {allowed,
notAllowed},
spare BIT STRING (SIZE (1))
}

Additionally, for at least some embodiments of this fourth scheme, the WUS configuration may be associated with one or more specific indications based on at least one state or field upon detection of a MIB, such as one state of the indication by pdcch-ConfigSIB1. After detecting the specific indication, the user device 102 may determine or be aware of the WUS configuration. In turn, the user device 102 may send the WUS to trigger the on-demand SIB1. In response to, or after receiving, the WUS, the network device 104 may send the SIB1.

Accordingly, using the above-described schemes for implicit indication, implementation of on-demand common information transmission can be achieved by WUS triggering through use of the corresponding WUS configuration, which may be provided by other common information transmitted before the on-demand common information transmission. As described in these schemes, the WUS configuration may be indicated implicitly by specific states of the other common information. As a result, on-demand common information transmission may be performed with relatively low complexity.

In addition or alternatively, in some embodiments, on-demand first common information (e.g. SIB1) may be triggered by a WUS without use of a PDCCH (i.e., in a PDCCH-less manner, that is, the first common information is not scheduled by PDCCH). For example, the SIB1 is not scheduled by PDCCH. For at least some of these embodiments, pdcch-ConfigSIB1 and kSSB (in some embodiments kSSB≤23 for FR1, kSSB≤11 for FR2) may be used to represent WUS configurations and/or SIB1 scheduling information.

Additionally, in some embodiments, scheduling information for a SIB1 may be indicated by certain information in, or associated with, a MIB, such as transport block size (TBS) or repetition number, as non-limiting examples. In addition or alternatively, the frequency domain location may be predefined and/or indicated by the MIB. Also, the time domain location may be implicitly derived based on other information, such as PCID as a non-limiting example.

In addition or alternatively, in some embodiments, one or more frequency domain resources, such as including the start location and/or the size of the SIB1, may be indicated by the MIB. For example, both a resource block (RB) offset and/or SCS offset for the start location, and/or the number of RBs for the size of SIB1 may be indicated. In some embodiments, the parameters of the one or more frequency domain resources may be independently indicated or jointly indicated based on a predefined or configured table.

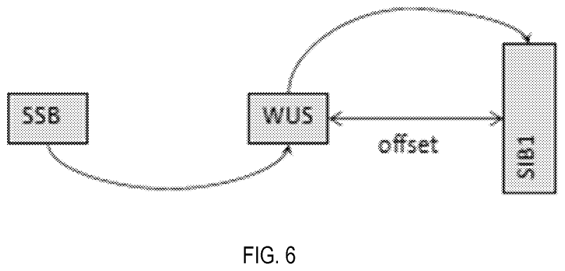

In addition or alternatively, scheduling information for the SIB1 may be explicitly or implicitly indicated or suggested by a WUS. For embodiments where an on-demand SIB1 is triggered by a user device 102 using a WUS, the user device 102 may indicate or suggest at least some of the scheduling information for the SIB1 using the WUS. FIG. 6 shows a schematic diagram of an example of a WUS indicating scheduling information for a SIB1. For example, as shown in FIG. 6, the start time of the time domain resource of the on-demand SIB1 may be derived based on the WUS, such as by an offset from the end of the WUS. In any of various embodiments, the offset may be indicated by the WUS, predefined, reported from the user device 102, or indicated, predefined, or configured by the network device 104.

Accordingly, using the above-described schemes for on-demand common information transmission in a PDCCH-less manner, implementation of on-demand common information transmission can be achieved by WUS triggering through use of the corresponding WUS configuration, which may be provided by other common information transmitted before the on-demand common information transmission. As described in these schemes, through transmission of the on-demand common information in a PDCCH-less manner, on-demand common information transmission may be performed with relatively low complexity.

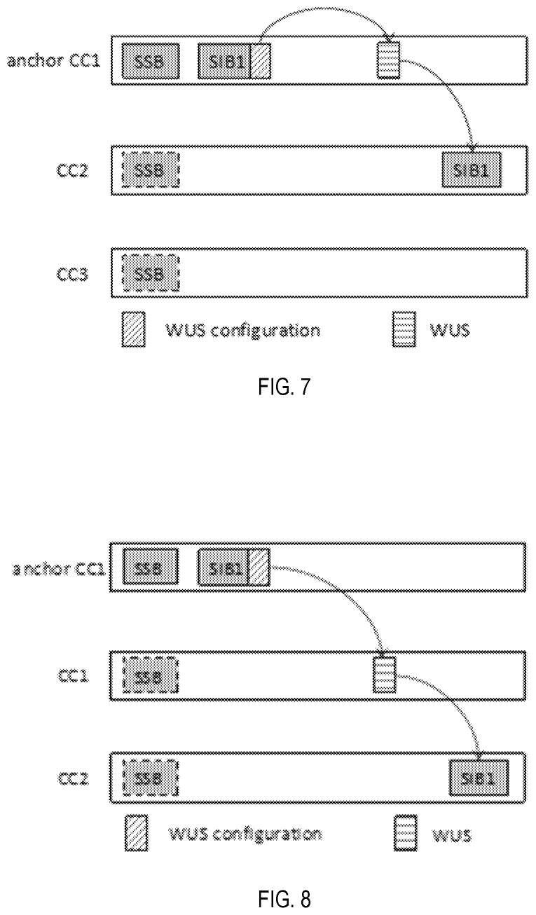

In addition or alternatively, a WUS on an anchor carrier and/or an anchor cell may be used to trigger the on-demand first common information on one or more non-anchor carriers and/or non-anchor cells. In at least some of these embodiments, a WUS may include an indication that indicates one or more carriers and/or one or more cells, or the carrier(s) and/or the cell(s) associated with the WUS may be predefined or configured (such as by the network device 104). In addition or alternatively, the WUS configuration and the WUS may be both transmitted on the anchor carrier and/or the anchor cell. As a result, besides the WUS configuration may be derived by the second common information in other embodiments, the WUS configuration can be configured by the RRC signalling (e.g. higher layer parameters) on the anchor carrier and/or the anchor cell. In addition or alternatively, the WUS configuration with carrier(s)/cell(s) indication may be applied to one or more non-anchor carriers and/or non-anchor cells. In such embodiments, the WUS may be transmitted on the one or more non-anchor carriers and/or the one or more non-anchor cells to trigger the on-demand first common information on the one or more non-anchor carriers and/or the one or more non-anchor cells. To illustrate, FIG. 7 shows a schematic diagram of an example transmission on anchor and non-anchor cells/carriers. As shown in FIG. 7, CC1 is an anchor cell/carrier, and CC2 and CC3 are each a non-anchor cell/carrier. Also, as used herein unless expressly described otherwise, the term CC (such as used for CC1, CC2, etc.) may refer to a component carrier, a carrier, or a cell. In the example in FIG. 7, a SSB and a SIB1 are transmitted on the anchor CC1; the WUS configuration for a WUS is transmitted on the anchor CC1 and is carried by the SIB1 on the anchor CC1. The WUS is transmitted by another device (e.g., another user device 102), and is used to trigger the on-demand SIB1 transmitted on non-anchor CC2 with a carrier indicator based on the WUS. Additionally, the network device 104 may transmit the on-demand SIB1 on the non-anchor CC2 after, or in response to, receiving the WUS on the anchor CC1. In any of various of these embodiments, a SSB on the non-anchor CC2 may be transmitted or not transmitted.

In addition or alternatively, in some embodiments, a WUS on a non-anchor carrier and/or a non-anchor cell may be used to trigger the on-demand first common information on the same carrier and/or the same cell, or on one or more non-anchor carriers and/or non-anchor cells. In some of these embodiments, a WUS may include an indicator that includes one or more carriers and/or one or more cells, or the one more carriers and/or the one or more cells associated with the WUS may be predefined or configured (such as by the network device 104). In addition or alternatively, in some of these embodiments, a WUS configuration may be transmitted on an anchor carrier and/or an anchor cell. In addition or alternatively, a WUS configuration with an indicator that indicates one or more carriers and/or one or more cells may be applied to one or more non-anchor carriers and/or one or more non-anchor cells, and the WUS may be transmitted on the one or more non-anchor carriers and/or one or more non-anchor cells to trigger the on-demand first common information on the one or more non-anchor carriers and/or non-anchor cells. To illustrate, FIG. 8 shows a schematic diagram of another example transmission on anchor and non-anchor cells/carriers. Similar to FIG. 7, in FIG. 8, CC1 is an anchor cell/carrier, and each of CC2 and CC3 is a non-anchor cell/carrier. In the example in FIG. 8, a SSB and a SIB1 are transmitted on the anchor CC1, and the WUS configuration for the WUS is transmitted on the non-anchor CC2 and is carried by the SIB1 on the anchor CC1. The WUS may be transmitted by another device (e.g., another user device 102), and is used to trigger the on-demand SIB1 transmitted on the non-anchor CC3 with a carrier indicator based on the WUS. The network device 104 may transmit the on-demand SIB1 on the non-anchor CC3 after, or in response to, receiving the WUS on the non-anchor CC2. In any of various of these embodiments, the SSB on or both of the non-anchors CC2, CC3 may be transmitted or not transmitted. Additionally, in at least some embodiments, in event there is no carrier indication based on the WUS, a default transmission for the on-demand SIB1 may be performed on the same carrier with WUS transmission.

In addition or alternatively, in some embodiments, a condition for a WUS transmission may be performed by another device (e.g., another user device 102) according to, based on, or in response to one of the following conditions. In a first condition, the other device is carrier and/or cell barred on the anchor carrier and/or the anchor cell. Additionally, the other device may transmit the WUS to trigger the on-demand SIB1 on one or more non-anchor carriers and/or non-anchor cells. In a second condition, a random access channel (RACH) failure has occurred on the anchor carrier and/or the anchor cell. In response, the other device may transmit the WUS to trigger the on-demand SIB1 on one or more non-anchor carriers and/or one or more non-anchor cells. In a third condition, the other device may transmit the WUS to trigger the on-demand SIB1 on one or more non-anchor carriers and/or one or more non-anchor cells based on, or in response to, one or more measurement result being lower than a threshold.

Accordingly, using the above-described schemes involving anchor and non-anchor cells and/or carrier, implementation of on-demand common information transmission can be achieved by WUS triggering through use of the corresponding WUS configuration, which may be provided by other common information transmitted on another carrier and/or cell before the on-demand common information transmission. As a result, on-demand common information transmission may be performed with relatively low complexity.

In addition or alternatively, in some embodiments, on-demand first common information on a carrier and/or a cell (e.g. a SIB1) may be triggered by a wake-up signal (WUS), which is transmitted from another device. The WUS may be a signal or channel (e.g. a PRACH, a DRS, a pulse signal, a PUSCH, a PUCCH, a SRS, or a reference signal, as non-limiting examples). Additionally, a WUS configuration may be delivered by a second common information from same or different carrier and/or cell. For example, the second common information may be carried by a L1 signal or channel (e.g., a SSB, a DRS, a PDCCH or SIB1) or a core network, which may be transmitted before the on-demand first common information. In some embodiments, a request for the WUS configuration may be sent from the another device.

In addition or alternatively, some embodiments may implement or utilize a condition for a WUS transmission or a request for the WUS configuration from another device. Such embodiments may or may not be used in combination with any of the previously described embodiments. For example, in any of various embodiments, a condition for a WUS transmission or a request for a WUS configuration may or may not be used in combination with embodiments that use a SSB to explicitly indicate a WUS configuration. As another example, in any of various embodiments, a condition for a WUS transmission or a request for a WUS configuration may or may not be used in combination with embodiments that use a SSB to implicitly indicate a WUS configuration. As still another example, in any of various embodiments, a condition for a WUS transmission or a request for a WUS configuration may or may not be used in combination with embodiments that use a WUS to trigger first common information in a PDCCH-less manner. As an additional example, in any of various embodiments, a condition for a WUS transmission or a request for a WUS configuration may or may not be used in combination with embodiments that use a WUS on a cell or an anchor (e.g., an anchor cell or an anchor carrier) to trigger first common information on the cell or the carrier on another one or more cells or another one or more carriers (e.g., one or more non-anchor cells or one or more non-anchor carriers). In addition, such embodiments may comprise one of the following conditions.

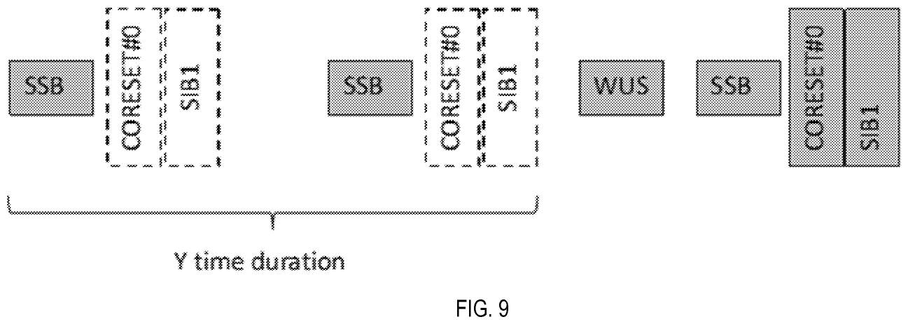

In a first condition, a PDCCH used for scheduling a SIB1 is not detected within X occasions and/or Y periods or durations. In some embodiments involving the first condition, a PDCCH used for scheduling a SIB1 may be transmitted in a Type0-PDCCH common search space (CSS) set of CORESET #0. In such embodiments, a user device 102 may send the WUS or the request for the WUS configuration in event that the PDCCH used for scheduling the SIB1 is not detected within X occasions and/or Y periods (or durations) in the time domain. For at least some of these embodiments, X and Y are integers. FIG. 9 shows a schematic diagram of the first condition, where a PDCCH used for scheduling a SIB1 is not detected within Y time durations or periods.

In a second condition, a timer or a duration used for SIB1 reception, a WUS transmission, or a request for a WUS configuration start is expired. In some embodiments involving the second condition, the timer is started when a SSB is detected and/or received, or the start time of the duration is the end of a detected and/or received SSB. For example, a timer used for SIB1 reception may be set to N milliseconds (ms), and when a user device 102 receives a SSB correctly, the timer is started. Before the timer expiration, the user device 102 may or may not try to detect the SIB1. When or after the timer expires, the user device 102 may send the WUS or the request for WUS configuration.

In a third condition, a SSB has been received within Z times and/or within P time duration/periods. In some embodiments involving the third condition, a user device 102 may send the WUS or the request for the WUS configuration if a SSB on a GSCN has been received Z times and/or within P time duration/periods. In at least some of these embodiments, each of Z and P are integers.

Additionally, in some embodiments, any one of the first, second or third conditions further includes that UL traffic arrived and/or a measurement result satisfies a certain threshold, such as by being lower or higher than the threshold.

In addition or alternatively, some embodiments involving the first condition and/or the second condition may include an SSB with a SIB1.

In addition or alternatively, some embodiments of the first condition, the second condition, and/or the third condition may include an SSB without SIB1, where at least one of pdcch-ConfigSIB1 and kSSB are reinterpreted to indicate a WUS configuration and/or on-demand SIB1 scheduling information.

Accordingly, using the above-described schemes involving one or more conditions (e.g., the above-described first, second, and/or third conditions), implementation of on-demand common information transmission can be achieved by WUS triggering through use of the corresponding WUS configuration, which may be provided by other common information transmitted before the on-demand common information transmission. As a result, on-demand common information transmission may be performed with relatively low complexity.

Additionally, in some embodiments, a relationship or correspondence between a WUS and an on-demand SIB1 may include one of following.

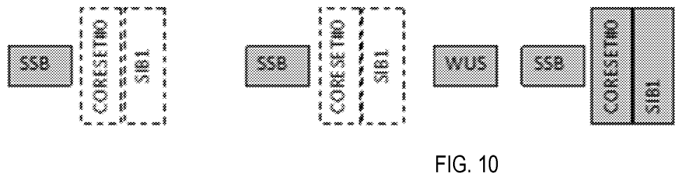

In a first relationship or correspondence between a WUS and an on-demand SIB1, a SIB1 may be sent periodically after being triggered by WUS. In some of these embodiments, the SIB1 may be sent periodically after being triggered by WUS until a cell off event. In particular of these embodiments, occurrence of a cell off event may be determined by the network device 104 (e.g., gNB) when there are no serving user devices 102. In addition or alternatively, a WUS may be sent one or more times until an on-demand SIB1 is received. In some embodiments, the SIB1 may be sent at least within a time offset after the WUS. In addition or alternatively, the SIB1 may be sent after a time offset starting at the end of the WUS. In addition or alternatively, a SSB may be updated after a WUS reception. In addition or alternatively, the SSB may be updated within a time offset after a WUS reception. In addition or alternatively, the SSB may be updated after a time offset starting at the end of the WUS reception. For example, after the WUS reception, the network device 104 may send the SIB1 periodically. FIG. 10 shows a schematic diagram of periodic transmission of a SIB1 after WUS reception. In addition or alternatively, a time offset between the WUS and the SIB1, or the WUS and the updated SSB may be applied based on at least one of the following: the SIB1 being sent after a time offset starting at the end of the WUS, the SSB being updated within a time offset after a WUS reception, or the SSB being updated after a time offset starting at the end of the WUS reception.

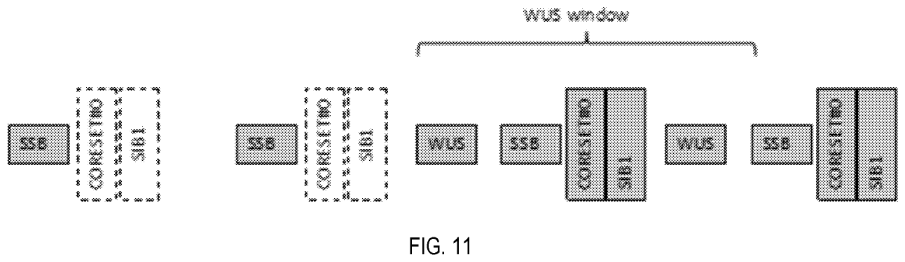

In a second relationship or correspondence, a WUS is sent based on a predefined rule. In this second relationship, the WUS is decoupled with reception of the on-demand SIB1. That is, the WUS may still be sent even though the user device 102 has already received the on-demand SIB1. In some of these embodiments, the predefined rule may be or include one of following. In a first predefined rule, the WUS may be transmitted once. If on-demand SIB1 is not received within a duration (which in some embodiments starts at the end of the WUS transmission), another WUS may be sent. In a second predefined rule, a WUS may be sent one or more times in a WUS window or a time duration with one or more WUS occasions. FIG. 11 shows a schematic diagram of an example of a WUS sent one or more times in a WUS window with multiple WUS occasions. In some embodiments implementing the second predefined rule, if the on-demand SIB1 is not received after the WUS is transmitted in the WUS window, the WUS may be sent in one or more additional WUS window(s). In addition or alternatively, in some embodiments implementing the second predefine rule, in event that the WUS is sent multiple times in a WUS window with multiple WUS occasions, a subsequent WUS may be sent in the same window in event that the on-demand SIB1 is received. In a third predefined rule, a WUS may be sent periodically, such as periodically within a certain or predetermined X periods. In some embodiments implementing the third predefined rule, in event that the on-demand SIB1 is received, the WUS transmission can be stopped.

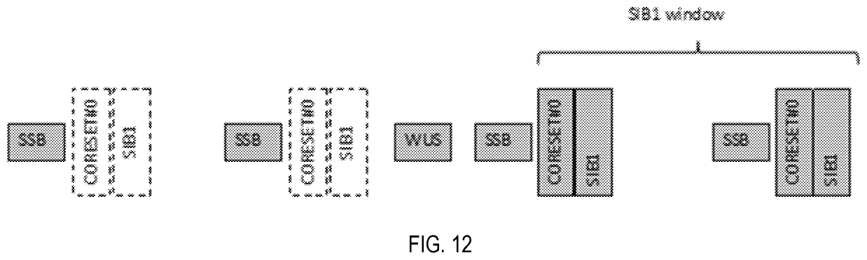

In a third relationship or correspondence, a SIB1 may be transmitted once or more times after being triggered by a WUS. In some embodiment of the third relationship, the on-demand SIB1 may be not be transmitted periodically until a cell off event, and/or may be transmitted several times within a certain or predetermined time duration. In addition or alternatively, the WUS may be sent one or more times until the on-demand SIB1 is received, or may be sent one or more times according to a predefined rule, such as one of the predefined rules of the second relationship as previously described. In particular of these embodiments, the on-demand SIB1 may be transmitted by or according to one of following schemes. In a first scheme, the SIB1 may be sent once after being triggered by the WUS. In some embodiments of the first scheme, if the SIB1 is not received by the user device 102 correctly, another WUS may be sent to trigger another transmission of the on-demand SIB1. In a second scheme, the SIB1 may be sent periodically within a certain or predetermined Y periods (where Y is an integer) after being triggered by the WUS. In a third scheme, the SIB1 may be sent periodically within a SIB1 window or a time duration after being triggered by WUS. FIG. 12 shows a schematic diagram of a SIB1 sent periodically within a SIB1 window. In some embodiments of the third scheme, the SIB1 window or time duration is determined by a timer. In addition or alternatively, the manner or way in which the SIB1 is transmitted (such as according to the first, second, or third schemes) may be indicated by the WUS used for triggering the on-demand SIB1. In other words, the WUS used to trigger the transmission of the on-demand SIB1 may also indicate how to transmit the on-demand SIB1, such as according to the first, second, or third schemes.

Also, embodiments using a relationship or correspondence between a WUS and first common information may or may not be used in combination with any of the previously described embodiments. For example, in any of various embodiments, a relationship or correspondence between a WUS and first common information may or may not be used in combination with embodiments that use a SSB to explicitly indicate a WUS configuration. As another example, in any of various embodiments, a relationship or correspondence between a WUS and first common information may or may not be used in combination with embodiments that use a SSB to implicitly indicate a WUS configuration. As still another example, in any of various embodiments, a relationship or correspondence between a WUS and first common information may or may not be used in combination with embodiments that use a WUS to trigger first common information in a PDCCH-less manner. As an additional example, in any of various embodiments, a relationship or correspondence between a WUS and first common information may or may not be used in combination with embodiments that use a WUS on a cell or a carrier (e.g., an anchor cell or an anchor carrier) to trigger first common information on the cell or the carrier, on another one or more cells or another one or more carriers (e.g., one or more non-anchor cells or one or more non-anchor carriers).

Accordingly, using the above-described schemes involving one or relationships or correspondence (e.g., the above-described first, second, and/or third relationships or correspondences), the WUS transmission and the on-demand information transmission may be coupled or linked together or may be uncoupled or unlinked together, and implementation of on-demand common information transmission can be achieved by WUS triggering through use of the corresponding WUS configuration, which may be provided by other common information transmitted before the on-demand common information transmission. As a result, on-demand common information transmission may be performed with relatively low complexity.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

The subject matter of the disclosure may also relate to or include, among others, the following aspects:

A first aspect includes a method for wireless communication that includes: transmitting, by a user device, a wake-up signal (WUS); receiving, by the user device, second common information that includes a WUS configuration corresponding to the WUS; and after receiving the second common information, receiving, by the user device, first common information, wherein transmission of the first common information is triggered by the WUS.

A second aspect includes a method for wireless communication that includes: receiving, by a network device, a wake-up signal (WUS); transmitting, by the network device, second common information that includes a WUS configuration corresponding to the WUS; and after transmitting the second common information, transmitting, by the network device, first common information, wherein transmission of the first common information is triggered by the WUS.

A third aspect includes any of the first or second aspects, and further includes wherein the WUS configuration is delivered by the second common information by: being indicated by one bit or one state in a master information block (MIB) of the second common information, wherein the one bit or the one state is used to indicate one of two predefined WUS configurations, or to indicate whether only one default predefined WUS configuration is delivered by the MIB; being indicated by one bit or one state in a MIB of the second common information to indicate that at least one other field of the MIB represents an indication of the WUS configuration; being associated with at least one synchronization signal (SS)/physical broadcast channel (PBCH) block (SSB) of the second common information or a number of received SSBs in a period; being associated with at least one global synchronization channel number (GSCN); being associated with at least one cell identifier (ID); or being associated with at least one state or field of a MIB of the second common information.

A fourth aspect includes the third aspect, and further includes wherein the WUS configuration is applied to a carrier or cell which is the same as or different than a cell or carrier used for the second common information transmission.

A fifth aspect includes any of the first through fourth aspects, and further includes wherein the transmission of the first common information is triggered by the WUS in a physical downlink control channel (PDCCH)-less manner.

A sixth aspect includes the fifth aspect, and further includes wherein a frequency domain resource comprising at least one of a start location or a size of a system information block 1 (SIB1) of the first common information is indicated by a master information block (MIB).

A seventh aspect includes the sixth aspect, and further includes wherein scheduling information for the SIB1 is explicitly or implicitly indicated by the WUS.

An eighth aspect includes the seventh aspect, and further includes wherein the scheduling information includes a start symbol or a start slot for the SIB1, which is from an end symbol or an end slot of the WUS.

A ninth aspect includes any of the first through eighth aspects, and further includes wherein the WUS is transmitted on a cell or a carrier, and the transmission of the first common information is triggered by the WUS on: the cell or the carrier; another cell or another carrier; or a plurality of other cells or a plurality of other carriers.

A tenth aspect includes the ninth aspect, and further includes wherein the WUS includes a cell indication or a carrier indication for the first common information transmission.

An eleventh aspect includes any of the first through tenth aspects, and further includes wherein at least one of the WUS transmission or a request for the WUS configuration is made in response to occurrence of a condition, wherein the condition includes one of: a physical downlink control channel (PDCCH) used for scheduling a system information block 1 (SIB1) of the first common information is not detected within a predetermined X occasions and/or a predetermined Y periods or time durations, wherein each of X and Y is an integer; a timer used for SIB1 reception, starting a WUS transmission, or starting a WUS configuration request has expired; or at least one synchronization signal and physical broadcast channel (PBCH) block (SSB) of the second common information is received within a predetermined Z times or a predetermined P time durations or periods, wherein each of Z and P is an integer.

A twelfth aspect includes any of the first through eleventh aspects, and further wherein a correspondence between the WUS and the first common information includes includes: the first common information is transmitted periodically after being triggered by the WUS until occurrence of a cell off event.

A thirteenth aspect includes the twelfth aspect, and further includes wherein the WUS is transmitted one or more times until the first common information is received.

A fourteenth aspect includes any of the first through thirteenth aspects, and further includes wherein a correspondence between the WUS and the first common information includes: the WUS is transmitted one or more times in a WUS window or a duration with one or more WUS occasions.

A fifteenth aspect includes the fourteenth aspect, and further includes wherein one or more subsequent WUSs are not sent in the WUS window or the duration in response to the on-demand first common information being received.

A sixteenth aspect includes any of the first through thirteenth aspects, and further includes wherein a correspondence between the WUS and the first common information includes: the first common information is sent one or more times after being triggered by the WUS.

A seventeenth aspect includes the sixteenth aspect, and further includes wherein the first common information is transmitted periodically within a predetermined Y periods after being triggered by the WUS, wherein Y is an integer.

An eighteenth aspect includes the sixteenth aspects, and further includes wherein the first common information is transmitted within a predetermined time window after the transmission of the first common information is triggered by the WUS.

A nineteenth aspect includes a wireless communications apparatus comprising a processor and a memory, wherein the processor is configured to read code from the memory to implement any of the first through eighteenth aspects.

A twentieth aspect includes a computer program product comprising a computer-readable program medium comprising code stored thereupon, the code, when executed by a processor, causing the processor to implement any of the first through eighteenth aspects.

In addition to the features mentioned in each of the independent aspects enumerated above, some examples may show, alone or in combination, the optional features mentioned in the dependent aspects and/or as disclosed in the description above and shown in the figures.

1. A method for wireless communication, the method comprising:
transmitting, by a user device, a wake-up signal (WUS);
receiving, by the user device, second common information comprising a WUS configuration corresponding to the WUS; and
after receiving the second common information, receiving, by the user device, first common information, wherein transmission of the first common information is triggered by the WUS.

2. The method of claim 1, wherein the WUS configuration is delivered by the second common information by:
being associated with at least one global synchronization channel number (GSCN).

3. The method of claim 2, wherein one or more synchronization signal blocks (SSBs) with the second common information are received on a certain GSCN of the at least one GSCN.

4. The method of 3, wherein the WUS configuration is associated with a SSB of the one or more SSBs that is received on the certain GSCN, and wherein the user device transmits the WUS based on the WUS configuration.

5. The method of claim 1, wherein a correspondence between the WUS and the first common information comprises:
the first common information is sent one or more times after being triggered by the WUS.

6. The method of claim 5, wherein the first common information is transmitted within a time duration after being triggered by the WUS.

7. The method of claim 1, wherein the first common information comprises a system information block 1 (SIB1).

8. A non-transitory computer-readable storage medium storing a plurality of instructions executable by at least one processor, wherein when executed by the at least one processor, the plurality of instructions is configured to cause the at least one processor to perform the method of claim 1.

9. A method for wireless communication, the method comprising:
receiving, by a network device, a wake-up signal (WUS);
transmitting, by the network device, second common information comprising a WUS configuration corresponding to the WUS; and
after transmitting the second common information, transmitting, by the network device, first common information, wherein transmission of the first common information is triggered by the WUS.

10. The method of claim 9, wherein the WUS configuration is delivered by the second common information by:
being associated with at least one global synchronization channel number (GSCN).

11. The method of claim 10, wherein one or more synchronization signal blocks (SSBs) with the second common information are transmitted on a certain GSCN of the at least one GSCN.

12. The method of claim 11, wherein the WUS configuration is associated with a SSB of the one or more SSBs that is transmitted on the certain GSCN, and wherein the network device receives the WUS based on the WUS configuration.

13. The method of claim 9, wherein a correspondence between the WUS and the first common information comprises:
the first common information is sent one or more times after being triggered by the WUS.

14. The method of claim 13, wherein the first common information is transmitted within a time duration after being triggered by the WUS.

15. The method of claim 9, wherein the first common information comprises a system information block 1 (SIB1).

16. A wireless communications apparatus comprising a memory storing a plurality of instructions, and at least one processor configured to execute the plurality of instructions, wherein upon execution of the plurality of instructions, the at least one processor is configured to cause the wireless communications apparatus to perform the method of claim 9.

17. A non-transitory computer-readable storage medium storing a plurality of instructions executable by at least one processor, wherein when executed by the at least one processor, the plurality of instructions is configured to cause the at least one processor to perform the method of claim 9.

18. A wireless communications apparatus comprising:
a memory storing a plurality of instructions; and
at least one processor configured to execute the plurality of instructions, wherein upon execution of the plurality of instructions, the at least one processor is configured to cause the wireless communications apparatus to:
transmit a wake-up signal (WUS);
receive second common information comprising a WUS configuration corresponding to the WUS; and
after receipt of the second common information, receive first common information, wherein transmission of the first common information is triggered by the WUS.

19. The wireless communications apparatus of claim 18, wherein the WUS configuration is delivered by the second common information by:
being associated with at least one global synchronization channel number (GSCN).

20. The wireless communications apparatus of claim 18, wherein a correspondence between the WUS and the first common information comprises:
the first common information is sent one or more times after being triggered by the WUS.
